(19) United States
(12) Patent Application Publication
(10) Pub. No.: US 2025/0158056 A1
(43) Pub. Date: May 15, 2025

(54) SULFUR CATHODES

(71) Applicant: Monash University, Clayton (AU)

(72) Inventors: Yingyi Huang, Clayton (AU); Mahdokht Shaibani, Clayton (AU); Matthew Hill, Clayton (AU); Mainak Majumder, Clayton (AU)

(21) Appl. No.: 18/877,488

(22) PCT Filed: Jun. 23, 2023
(86) PCT No.: PCT/AU2023/050575

§ 371 Date: Dec. 20, 2024

(30) Foreign Application Priority Data
Jun. 23, 2022 (AU) 2022901733

(51) Int. Cl. H01M 4/58; H01M 4/02; H01M 10/0525

(52) U.S. Cl. CPC H01M 4/5815; H01M 10/0525; H01M 2004/021

(57) ABSTRACT

Sulfur cathodes which include cellulosic compositions containing a plurality of anionically functionalised cellulose nanofibres are described. The anionically functionalised cellulose nanofibres are highly charged and have a low aspect ratio. The sulfur cathodes possess low porosity, high surface smoothness and facilitate the transport of Li ions while hindering the transport of polysulfide anions. Batteries employing the sulfur cathodes have high gravimetric and volumetric density.

### FIELD OF THE DISCLOSURE

The present disclosure relates to sulfur cathodes and to lithium sulfur batteries incorporating the sulfur cathodes. The sulfur cathodes contain anionically functionalised cellulose nanofibres which exhibit high surface charge.

### BACKGROUND OF THE DISCLOSURE

Compared to lithium ion (Li-ion) battery technology, lithium sulfur (Li—S) batteries offer a number of potential advantages, including improved gravimetric energy density, reduced raw material cost due to the low cost of sulfur compared to the transition metals employed in Li-ion systems, and a reduced environmental impact of the cell materials.

However, the production of viable Li—S batteries has been hampered by a number of problems, including the inherent insulating properties of sulfur, the so-called polysulfide “shuttling effect”, in which polysulfide dissolution in the electrolyte results in loss of sulfur from the cathode, and the volume expansion of the sulfur cathode during operation.

Accordingly, there remains a need to provide sulfur cathodes that address one or more of these problems. The present disclosure is related to these needs.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE DISCLOSURE

In one aspect the present disclosure provides a sulfur cathode comprising:
a) a cellulosic composition comprising a plurality of anionically functionalised cellulose nanofibres;
b) one or more sulfur containing materials; and
c) one or more conductive materials.

In embodiments, the sulfur cathode comprises:
a) about 2 wt. % to about 20 wt. % of a cellulosic composition comprising a plurality of anionically functionalised cellulose nanofibres;
b) about 60 wt. % to about 80 wt. % of one or more sulfur containing materials; and
c) about 10 wt. % to about 30 wt. % of one or more conductive materials.

In embodiments, the sulfur cathode comprises:
a) about 5 wt. % to about 15 wt. % of a cellulosic composition comprising a plurality of anionically functionalised cellulose nanofibres;
b) about 65 wt. % to about 75 wt. % of one or more sulfur containing materials; and
c) about 15 wt. % to about 25 wt. % of one or more conductive materials.

In embodiments, the plurality of anionically functionalised cellulose nanofibres have one or more of the following characteristics:
a) a fibril diameter from about 0.1 nm to about 20 nm;
b) a fibril length from about 20 nm to about 1000 nm;
c) a fibril aspect ratio from about 10 to about 1000; and
d) a zeta potential more negative than about-60 mV.

In embodiments, the one or more sulfur containing materials comprise one or more of elemental sulfur, Li₂S and MoS₂.

In embodiments, the one or more conductive materials comprise one or more of carbon black, graphite, graphene, activated carbon, carbon nanotubes, and carbon fibre.

In embodiments, the cathode has a porosity of less than about 50%, or less than about 40%.

In embodiments, the cathode has an arithmetic surface roughness of less than about 25 μm.

In embodiments, the transportation of polysulfide anions within the cathode is hindered relative to a sulfur cathode absent the herein disclosed cellulosic composition.

In embodiments, the transportation of lithium ions within the cathode is facilitated relative to a sulfur cathode absent the herein disclosed cellulosic composition.

In another aspect the present disclosure provides a lithium sulfur battery comprising a lithium anode, a separator, the cathode according to any one of the herein disclosed embodiments, and electrolyte disposed between the anode and cathode.

In embodiments, the ratio of electrolyte volume to sulfur weight in the lithium sulfur battery is less than about 6.0 μl/mg.

In embodiments, the ratio of electrolyte volume to sulfur weight in the lithium sulfur battery is from about 3.5 to about 5.0 μl/mg.

During charging or discharging, the sulfur cathode may facilitate the transport of lithium ions through the cathode.

During charging or discharging, the sulfur cathode may hinder the transport of polysulfide ions through the cathode.

In embodiments, the plurality of anionically functionalised cellulose nanofibres have a fibril diameter from about 0.5 nm to about 10 nm, or from about 1 nm to about 6 nm, of from about 2 nm to about 4 nm.

In embodiments, the plurality of anionically functionalised cellulose nanofibres have a fibril length from about 40 nm to about 700 nm, or from about 70 nm to about 500 nm, or from about 100 nm to about 400 nm.

In embodiments, the plurality of anionically functionalised cellulose nanofibres have a fibril aspect ratio from about 15 to about 750, or from about 20 to about 500, or from about 25 to about 200.

In embodiments, the plurality of anionically functionalised cellulose nanofibres have a zeta potential from about-60 mV to about-90 mV.

In embodiments, the plurality of anionically functionalised cellulose nanofibres are functionalised with one or more of carboxyl, phosphonate, sulfonate, sulphate, hydroxyl, nitrate, and carbonate.

In embodiments, the plurality of anionically functionalised cellulose nanofibres comprise greater than 1 mmol anionic groups per gram nanofibres, or greater than 1.5 mmol anionic groups per gram nanofibres.

In embodiments, the plurality of anionically functionalised cellulose nanofibres comprise from about 1 to about 4 mmol anionic groups per gram nanofibres, or from about 1.5 to about 4 mmol anionic groups per gram nanofibres, or from about 2 to about 4 mmol anionic groups per gram nanofibres.

In embodiments, the plurality of anionically functionalised cellulose nanofibres are functionalised with carboxyl groups.

In another aspect the present disclosure provides a cathode slurry composition comprising:
a) a cellulosic composition comprising a plurality of anionically functionalised cellulose nanofibres;
b) one or more sulfur containing materials;
c) one or more conductive materials; and
d) water.

In embodiments, the ratio of water to the combined weights of components a), b) and c) is from about 1 ml/g to about 40 ml/g, or from about 3 ml/g to about 30 ml/g.

In embodiments, the viscosity of a 3 ml/g slurry at 0.01 s⁻¹ shear rate is greater than about 1000 Pa·s when measured in the temperature range 20-25° C.

In another aspect the present disclosure provides a method of preparing a cathode slurry composition according to any one of the herein disclosed embodiments, comprising the step of mixing a cellulosic composition comprising a plurality of anionically functionalised cellulose nanofibres, one or more sulfur containing materials, one or more conductive materials, and water.

In embodiments of the method, the cellulosic composition, one or more sulfur containing materials, and one or more conductive materials are dry mixed prior to mixing with water.

In another aspect the present disclosure provides a cellulosic composition comprising a plurality of anionically functionalised cellulose nanofibres, said nanofibres having one or more of the following characteristics:
a) a fibril diameter from about 0.1 nm to about 20 nm;
b) a fibril length from about 20 nm to about 1000 nm;
c) a fibril aspect ratio from about 10 to about 1000; and
d) a zeta potential more negative than about-60 mV.

In another aspect the present disclosure provides a method of preparing the cellulosic composition according to any one of the herein disclosed embodiments, comprising:
a) treating a source of cellulose with one or more agents capable of anionically functionalising cellulose nanofibres; and
b) subjecting the anionically functionalised cellulose nanofibres to shear conditions so as to reduce one or more fibril dimensions.

In embodiments, the shear conditions comprise agitating an aqueous mixture of the anionically functionalised cellulose nanofibres.

In embodiments, the shear conditions comprise one or both of ultrasonic homogenisation and high pressure homogenisation of an aqueous mixture of the anionically functionalised cellulose nanofibres.

Advantages of the presently disclosed sulfur cathodes and batteries including the sulfur cathodes include one or more of the following:
the sulfur cathodes have high ionic and electrical conductivity;
the sulfur cathodes have relatively low porosity;
the sulfur cathodes have a relatively smooth surface;
the sulfur cathodes possess advantageous transport effects, facilitating Li ion transport yet hindering polysulfide ion transport;
the sulfur cathode slurries have rheological properties which facilitate processing;
batteries employing the sulfur cathodes exhibit high gravimetric and volumetric energy density.

Any embodiment herein shall be taken to apply mutatis mutandis to any other embodiment unless specifically stated otherwise.

The present disclosure is not to be limited in scope by the specific embodiments described herein, which are intended for the purpose of exemplification only. Functionally-equivalent products, compositions and processes are clearly within the scope of the disclosure, as described herein.

Further aspects of the present disclosure and further embodiments of the aspects described in the preceding paragraphs will become apparent from the following description, given by way of example and with reference to the accompanying drawings.

### BRIEF DESCRIPTION OF THE DRAWINGS

FIG. 1 contains polarized light microscopy images of cellulose nanofibre (CNF) and of sulfur cathode; (a) Pol-Scope image of native CNF, illustrating thick and long fibres (scales 100 μm); (b) Pol-Scope image of carboxylated CNF, showing separated and short fibres due to further TEMPO oxidation; Pol-Scope images (c) Native CNF cathode; (d) carboxylated CNF cathode; (e) to (g) carboxylated CNF cathode at a concentration of 3.3 mg/ml, 33.3 mg/ml and 333.3 mg/ml respectively.

FIG. 2 illustrates characterizations of CNFs with different surface charges; (a) apparent zeta potential comparison between different carboxylated CNF samples and CMC (carboxymethyl cellulose), providing evidence of high surface charged carboxylated CNF, which may prevent aggregation and aid in ionic movement; (b) steady-state shear flow behaviour; (c) contact angle measurement of an electrolyte droplet on the carboxylated CNF films; (d) ionic conductivity as measured by AC impedance technique.

FIG. 3 illustrates morphology and microstructural study of sulfur cathode; (a) CMC cathode profilometer examination; (b) and (c) CMC cathode top-view SEM images at 50 and 1 μm scales respectively; (d) carboxylated CNF cathode profilometer examination; (e) to (i) carboxylated CNF cathode top-view SEM images at 50 μm, 1 μm, 200 nm, 500 nm, and 200 nm scales respectively; (j) schematic illustration of carboxylated CNF backbone; (k) to (m) cross-sectional SEM images of carboxylated CNF cathode at 10 μm, 1 μm, and 200 nm scales respectively.

FIG. 4 shows (a) schematic illustration of EBAC test; (b) EBAC current comparison between CMC (lower trace) and carboxylated CNF (upper trace) cathodes: (c) cross-sectional SEM images of CMC thick cathode (20 μm scale) and (d) carboxylated CNF thick cathode (20 μm scale); (e) EBAC processing images of CMC thick cathode and (f) carboxylated CNF thick cathode.

FIG. 5 illustrates coin cell level cycling performance of carboxylated CNF cathodes; (a) carboxylated CNF cathodes with sulfur loading around 1 mg cm⁻², the four data curves spanning the middle of the plot represent, from top to bottom, CNF2, CNF1.5, CNF1.4 and CNF1.2 respectively; (b) rate capability data among carboxylated CNF cathodes with sulfur loading around 1 mg cm 2; (c) coin cells configured with 7 mg cm⁻² sulfur loaded carboxylated CNF cathodes; (d) 11 mg cm⁻² sulfur loaded carboxylated CNF cathodes and 14 mg cm⁻² sulfur loaded carboxylated CNF cathodes shown in the insert plot; (e) discharge areal capacity comparison among carboxylated CNF cathodes with different sulfur loading; (f) specific capacity and areal capacity versus sulfur loading of carboxylated CNF cathodes.

FIG. 6 illustrates pouch cell performance; (a) long term cycling of pouch cell with carboxylated CNF cathode; (b) Ah level pouch cell with carboxylated CNF cathode, the pouch cell configuration is shown in the inset plot; (c) discharge profiles of carboxylated CNF pouch and evolution of cycling life from the first cycle to the fortieth cycle and the weight of each component to calculate the specific energy shown in the insert table; (d) calculated specific energy versus capacity of cathode for Li—S pouch cells with different nominal voltage; (e) cycling profile of two 2.5 Ah pouch cells connected in series, insert photo demonstrating an application of the pouches pack as power supply batteries for a drone; (f) cell performance comparison between the presently disclosed Ah level carboxylated CNF pouch cell and previously reported Ah level Li—S pouch cells.

FIG. 7 shows SEM images of ex situ post-mortem of lithium metal anodes and sulfur cathodes from Li—S pouch cells after an intense cycling regime; (a) to (c) top-view SEM images of lithium anodes; (d) cross-sectional observation and (e) to (f) top-view SEM image of carboxylated CNF cathodes at full charge state.

FIG. 8 shows transmission electron microscopy (TEM) images of (a) native CNFs and (b) carboxylated CNFs.

### DETAILED DESCRIPTION OF THE EMBODIMENTS

It will be understood that the disclosure described and defined in this specification extends to all alternative combinations of two or more of the individual features mentioned or evident from the text or drawings. All of these different combinations constitute various alternative aspects of the disclosure.

### Definitions

For purposes of interpreting this specification, terms used in the singular will also include the plural and vice versa.

As used herein, except where the context requires otherwise, the term “comprise” and variations of the term, such as “comprising”, “comprises” and “comprised”, are not intended to exclude further additives, components, integers or steps.

“About” as used herein when referring to a measurable value such as an amount, a temporal duration, and the like, is meant to encompass variations of ±20% or ±10%, in some instances±5%, in some instances±1%, and in some instances±0.1% from the specified value, as such variations are appropriate to perform the disclosed methods.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The present disclosure relates to new sulfur cathodes for lithium sulfur batteries. The cathodes contain anionically functionalised cellulose nanofibres which possess high surface charge. Lithium sulfur batteries incorporating the new sulfur cathodes possess a number of advantageous properties.

Sulfur cathodes

The sulfur cathodes according to the present disclosure comprise a mixture of a cellulosic composition comprising a plurality of anionically functionalised cellulose nanofibres, one or more sulfur containing materials, and one or more conductive materials.

In embodiments, the presently disclosed sulfur cathodes comprise:
a) about 2 wt. % to about 20 wt. % of a cellulosic composition comprising a plurality of anionically functionalised cellulose nanofibres;
b) about 60 wt. % to about 80 wt. % of one or more sulfur containing materials; and
c) about 10 wt. % to about 30 wt. % of one or more conductive materials.

In embodiments, the presently disclosed sulfur cathodes comprise:
a) about 5 wt. % to about 15 wt. % of a cellulosic composition comprising a plurality of anionically functionalised cellulose nanofibres;
b) about 65 wt. % to about 75 wt. % of one or more sulfur containing materials; and
c) about 15 wt. % to about 25 wt. % of one or more conductive materials.

In embodiments, the presently disclosed sulfur cathodes comprise from about 2 wt. % to about 20 wt. % cellulosic composition, or from about 3 wt. % to about 20 wt. %, or from about 4 wt. % to about 20 wt. %, or from about 5 wt. % to about 20 wt. %, or from about 5 wt. % to about 19 wt. %, or from about 5 wt. % to about 18 wt. %, or from about 5 wt. % to about 17 wt. %, or from about 5 wt. % to about 16 wt. %, or from about 5 wt. % to about 15 wt. % cellulosic composition.

The one or more sulfur containing materials include one or more of elemental sulfur, Li₂S and MoS₂. Other sulfur containing materials typically utilised in the construction of sulfur cathodes are contemplated.

In embodiments, the presently disclosed sulfur cathodes comprise from about 60 wt. % to about 80 wt. % of one or more sulfur containing materials, or from about 61 wt. % to about 80 wt. %, or from about 62 wt. % to about 80 wt. %, or from about 63 wt. % to about 80 wt. %, or from about 64 wt. % to about 80 wt. %, or from about 65 wt. % to about 80 wt. %, or from about 60 wt. % to about 79 wt. %, or from about 60 wt. % to about 78 wt. %, or from about 60 wt. % to about 77 wt. %, or from about 60 wt. % to about 76 wt. %, or from about 60 wt. % to about 75 wt. % of one or more sulfur containing materials.

The one or more conductive materials comprise one or more of carbon black, graphite, graphene, activated carbon, carbon nanotubes, and carbon fibre. Other conductive materials typically utilised in the construction of sulfur cathodes are contemplated.

In embodiments, the presently disclosed sulfur cathodes comprise from about 10 wt. % to about 30 wt. % of one or more conductive materials, or from about 11 wt. % to about 30 wt. %, or from about 12 wt. % to about 30 wt. %, or from about 13 wt. % to about 30 wt. %, or from about 14 wt. % to about 30 wt. %, or from about 15 wt. % to about 30 wt. %, or from about 15 wt. % to about 29 wt. %, or from about 15 wt. % to about 28 wt. %, or from about 15 wt. % to about 27 wt. %, or from about 15 wt. % to about 26 wt. %, or from about 15 wt. % to about 25 wt. % of one or more conductive materials.

### Anionically Functionalised Cellulose Nanofibres

Cellulose nanofibres are an integral component of delignified wood. They are characterised by an aligned, one-dimensional hierarchical structure rich in oxygen-containing polar functional groups (mostly hydroxyl) in the form of repeating anhydroglucose units that make up the cellulose molecular chains.

Cellulose nanofibres may be functionalised with a range of anionic functions. Examples of anionic functionality include carboxyl, phosphonate, sulfonate, sulphate, hydroxyl, nitrate, and carbonate.

The degree of anionic functionality may be expressed as mmol anionic function per gram functionalised cellulose nanofibres. In embodiments, the plurality of anionically functionalised cellulose nanofibres comprise greater than 1 mmol anionic groups per gram nanofibres, or greater than 1.25 mmol anionic groups, or greater than 1.5 mmol anionic groups, or greater than 1.75 mmol anionic groups, or greater than 2.0 mmol anionic groups, or greater than 2.25 mmol anionic groups, or greater than 2.75 mmol anionic groups, or greater than 3.0 mmol anionic groups, or greater than 3.25 mmol anionic groups, or greater than 3.5 mmol anionic groups per gram nanofibres.

In embodiments, the plurality of anionically functionalised cellulose nanofibres comprise from about 1 to about 4 mmol anionic groups per gram nanofibres, or from about 1.5 to about 4 mmol anionic groups, or from about 2.0 to about 4 mmol anionic groups, or from about 2.5 to about 4 mmol anionic groups per gram nanofibres.

In embodiments, the plurality of anionically functionalised cellulose nanofibres may be characterised by having fibrils of advantageous length, diameter and aspect ratio, and high surface charge.

In embodiments, the plurality of anionically functionalised cellulose nanofibres have a fibril diameter from about 0.1 nm to about 20 nm, or from about 0.5 nm to about 10 nm, or from about 1 nm to about 6 nm, of from about 2 nm to about 4 nm.

In embodiments, the plurality of anionically functionalised cellulose nanofibres have a fibril length from about 20 nm to about 1000 nm, or from about 40 nm to about 700 nm, or from about 70 nm to about 500 nm, or from about 100 nm to about 400 nm.

In embodiments, the plurality of anionically functionalised cellulose nanofibres have a fibril aspect ratio from about 10 to about 1000, or from about 15 to about 750, or from about 20 to about 500, or from about 25 to about 200.

The anionically functionalised cellulose nanofibres according to the present disclosure may possess high surface charge. In embodiments, the zeta potential of the anionically functionalised cellulose nanofibres may be more negative than about-60 mV, or more negative than about-65 mV, or more negative than about-70 mV, or more negative than about-75 mV, or more negative than about-80 mV.

In embodiments, the zeta potential of the anionically functionalised cellulose nanofibres may be from about-60 mV to about-90 mV, or from about-60 mV to about-90 mV, or from about-60 mV to about-80 mV, or from about-70 mV to about-90 mV, or from about-70 mV to about-80 mV.

Without wishing to be bound by theory it is envisaged that due to the resulting negatively charged microenvironment, the anionic groups of the functionalised cellulose nanofibres when employed as a constituent of a sulfur cathode can facilitate the transportation of Li ions, but enable electrostatic repulsion of polysulfides possessing anionic characteristics.

### Preparation of Anionically Functionalised Cellulose Nanofibres

Native cellulose nanofibres may be treated with appropriate agents so as to introduce anionic functions into the cellulose molecular chain. A number of methods for introducing such functions are known in the art.

For example, a useful method of introducing carboxyl functionality is described in Mendoza, D. J., Browne, C., Raghuwanshi, V. S., Simon, G. P. & Garnier, G. One-shot TEMPO-periodate oxidation of native cellulose. Carbohydrate polymers 226, 115292 (2019).

Subsequent to anionic functionalisation of the cellulose nanofibres, they may be subjected to high shear conditions so as to reduce one or more fibril dimensions. Suitable high shear conditions include one or more of, for example, high pressure homogenisation, ultrasonic homogenisation, grinding, and cryomilling.

### Sulfur Cathode Characteristics

A feature of the presently disclosed sulfur cathodes is their relatively low porosity. This is advantageous as it minimises cathode pore volume and therefore electrolyte volume.

The porosity of the sulfur cathode may be less than about 50%, or less than about 45%, or less than about 40%, or less than about 35%.

Another advantageous feature of the presently disclosed sulfur cathodes is their relatively low surface roughness. In embodiments, the cathode has an arithmetic surface roughness of less than about 25 μm, or less than about 20 μm, or less than about 15 μm, or less than about 10 μm. In embodiments, the arithmetic surface roughness may be from about 5 μm to about 25 μm, or from about 5 μm to about 20 μm, or from about 5 μm to about 15 μm.

Without being bound by theory, the observed low surface roughness may be attributed to the self-relaxation and orientation abilities of the semi-crystalline anionically functionalise cellulose nanofibres. The sulfur cathodes may contain fewer agglomerated particles due to the repulsive force generated by the cellulose nanofibres high apparent surface charge. Considering cathodes in lithium metal battery systems, every tip of a rough surface has a high electric field, which attracts more Li-ion flux and promotes the formation of dentrites. From this point of view, a useful cathode should desirably feature a relatively smooth surface, especially for large-scale applications, to minimise the reduplication and amplification of surface defects.

### Preparation of Sulfur Cathodes

The presently disclosed sulfur cathodes may be prepared by first combining the cellulosic composition comprising a plurality of anionically functionalised cellulose nanofibres, with one or more sulfur containing materials, one or more conductive materials and water to form a cathode slurry.

In some embodiments, the solid components are dry mixed prior to combining with the water.

An advantageous property of the presently disclosed cathode slurry is its viscosity. In embodiments, the viscosity of a 3 ml water/g total solids slurry at 0.01 s⁻¹ shear rate is greater than about 1000 Pa·s when measured in the temperature range 20-25° C.

In embodiments, the viscosity of a 3 ml/g slurry at 0.01 s⁻¹ shear rate is from about 1000 Pa·s to about 3000 Pa·s when measured in the temperature range 20-25° C.

Useful cathode slurries may be prepared with a ratio of water to total solids from about 3 ml/g to about 30 ml/g.

Sulfur cathodes may be prepared by coating the cathode slurry on aluminium foil and drying. Optionally, the coated foil may be subjected to calendering.

### Lithium Sulfur Batteries

The present disclosure provides a lithium sulfur battery comprising a lithium anode, a separator, the cathode according to any one of the herein disclosed embodiments, and electrolyte disposed between the anode and cathode.

In embodiments, the ratio of electrolyte volume to sulfur weight in the lithium sulfur battery is less than about 6.0 μl/mg.

In embodiments, the ratio of electrolyte volume to sulfur weight in the lithium sulfur battery is less than about 6.0 μl/mg, or less than about 5.5 μl/mg, or less than about 5.0 μl/mg, or less than about 4.5 μl/mg, or less than about 4.0 μl/mg, or less than about 3.5 μl/mg.

In embodiments, the ratio of electrolyte volume to sulfur weight in the lithium sulfur battery is from about 3.5 to about 5.0 μl/mg.

Typical separators known in the art of lithium sulfur batteries may be employed.

Coin cells prepared with cathodes comprising 70 wt. % sulfur, 20 wt. % carbon and 10 wt. % carboxylated cellulose nanofibres (about 2 mmol carboxyl groups per gram nanofibres) with a sulfur loading of 16.6 mg cm⁻² delivered areal capacity as high as 25 mAh cm⁻², which equates to 1500 mAh g⁻¹ specific capacity and 89% sulfur utilization, while achieving >98% columbic efficiency.

Ah-level Li—S pouch cells prepared with similar cathode composition delivered an initial capacity above 1200 mAh g⁻¹ and areal capacity around 15 mAh cm⁻², yielding high gravimetric energy of up to 330 Wh kg⁻¹ and volumetric energy density 367 Wh L⁻¹.

### EXAMPLES

### Materials

Elemental sulfur was purchased from Sigma-Aldrich. Conductive carbon powder as CABOT black pearl 2000 was purchased from Shandong Gelon LIB Co., LTD, China. Cellulose nanofibres (CNF) were supplied by The University of Maine, USA, or BioPRIA, Monash University, Australia. Carbon coated glass fibre interlayers were comprised of carbon (ASAC30, Adven Industries Inc., Canada), Gum Arabic (HawkinsWatts) and glass fibre (BG03013 separator, Hollingsworth & Vose, USA). Bis (trifluoromethane) sulphonamide lithium salt and lithium nitrate were purchased from Sigma-Aldrich and directly used without any further purification. 1,2-Dimethoxyethane (DME) and dioxolane (DOL) solvents were purchased from Sigma-Aldrich. Li₂S was purchased from Alfa Aesar for lithium polysulfide synthesis. Battery grade aluminium foil was purchased from Japan Capacitor Industrial Co. Battery grade copper foil was purchased from Shandong Gelon LIB Co., LTD, China. Celgard 2730 separator was purchased from Celgard Inc., USA. CNT was purchased from Nano Fibers, UK. Lithium chips (16*0.2 mm) were purchased from Shandong Gelon LIB Co., LTD, China.

### Preparation of Carboxylated Cellulose Nanofibres

Carboxylated cellulose nanofibres were synthesised via a one-shot 2,2,6,6-tetramethylpiperidine-1-oxyl (TEMPO)-periodate oxidation of bleached Eucalyptus Kraft pulp (BEK) of the native cellulose nanofibres (CNFs) as described in Mendoza, D. J., Browne, C., Raghuwanshi, V. S., Simon, G. P. & Garnier, G. One-shot TEMPO-periodate oxidation of native cellulose. Carbohydrate polymers 226, 115292 (2019). High-pressure or ultrasonic homogenisation of the resulting oxidised BEK fibres resulted in the formation of highly charged cellulose nanofibres. In an example, suspensions of the oxidised fibres (0.01 wt %) were sonicated for 2 min using an ultrasonic homogeniser at 19.5 kHz and 70% amplitude (ON/OFF, 5 s).

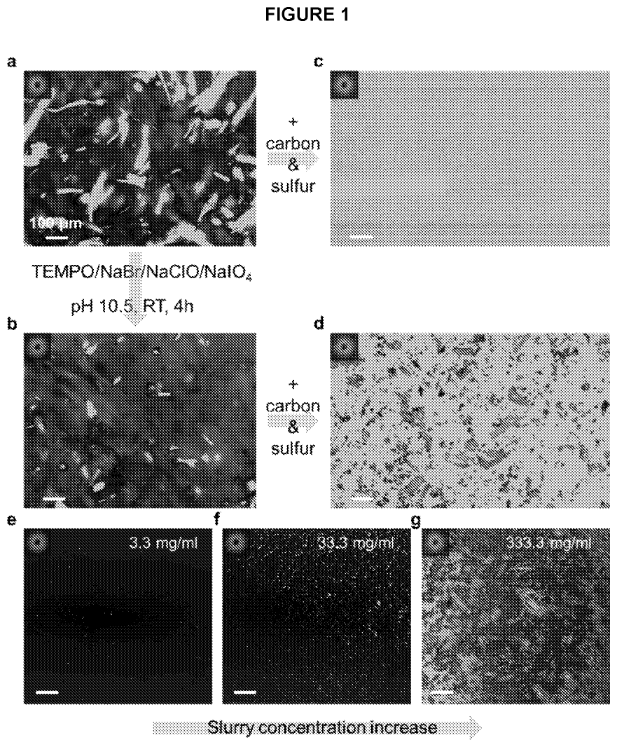

Aqueous native cellulose nanofibre dispersions were imaged by polarized light microscopy using an LC-PolScope microscope. As shown in FIG. 1a, highly-birefringent areas were observed with alignment domain lengths around 100-200 μm and widths around 20-50 μm. In contrast the carboxylated CNFs had significantly smaller dimensions (FIG. 1b; alignment domain length around 30-50 μm and width around 10-20 μm) compared to native CNFs.

### The Effects of Surface-Charge and Aspect-Ratio of Cellulose Nanofibre

Studies were conducted on a range of carboxylated CNFs with various carboxylate group content. Generally, the fibres are broken down as more carboxylate groups are introduced, resulting in increased surface charge and decreased aspect-ratio.

Samples labelled CNF2, CNF1.5, CNF1.4 and CNF1.2 were prepared containing nominally 2, 1.5, 1.4 and 1.2 mmol carboxyl groups per gram solids.

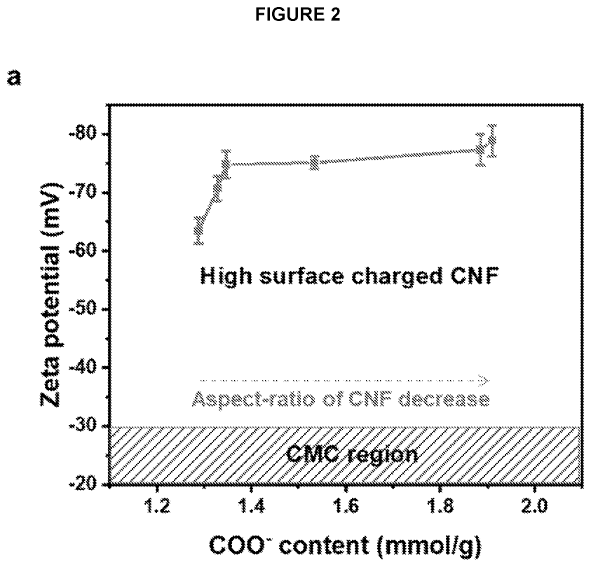

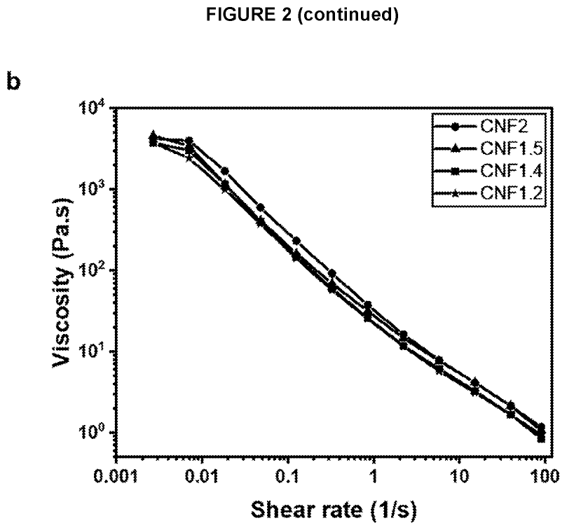

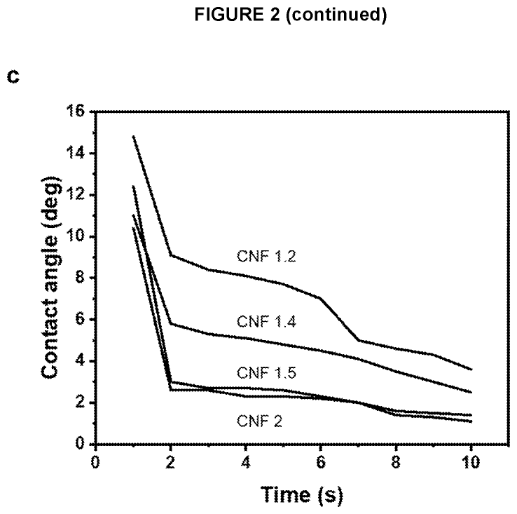

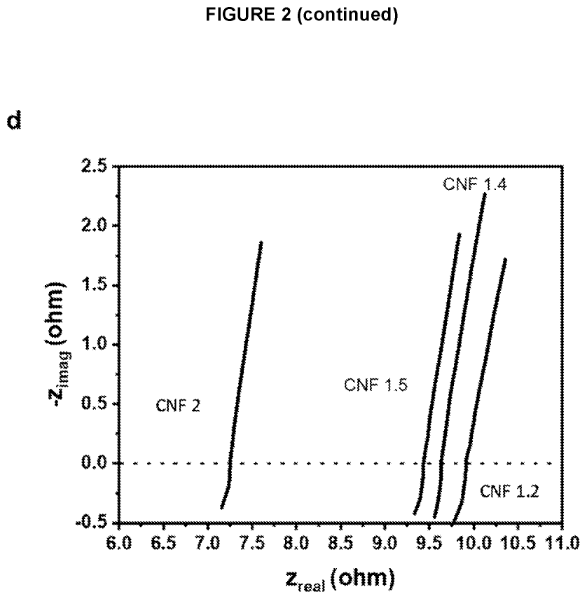

FIG. 2a shows the relationship between the carboxylate content of the CNF samples and their corresponding surface charge as measured by zeta potential. Levels of carboxylate content between about 1.3 mmol/g and 1.9 mmol/g were examined. High levels of carboxylate groups resulted in significant surface charge, as high as −80 mV.

Additionally, lithium polysulfide adsorption tests provided evidence of polysulfide restriction within the highly charged carboxylated solids. Compared to carboxymethyl cellulose (CMC), a commonly used cellulose binder in electrode manufacture, and which has a relatively low surface charge (−20 to 30 mV; see FIG. 2a), polysulfide adsorption was less.

The carboxylated CNF solids with different surface charges were dispersed in water, and subjected to rheology tests. The steady-state shear rheology, depicted in FIG. 2b, shows that all carboxylated CNF samples have a similar degree of shear-thinning characteristics. However, a steady increase of the zero-shear viscosity of carboxylated CNF samples with surface charge was observed. This was likely due to the higher fibrillation level promoted by the repulsion among the negatively charged carboxylated CNFs, resulting in a high nanofibre content and strong network structure.

The electrolyte wettability of carboxylated CNF films is represented by the contact angle between the films and electrolyte drops, as shown in FIG. 2c. The contact angles of the samples decrease within 10 seconds after a drop of electrolyte falls on the surface of the carboxylated CNF films. From the plot in FIG. 2c, it can be clearly observed that an increase in the surface charge decreases the contact angle. It is likely that the increase in carboxylate group concentration weakens the hydrogen bonds between the hydroxyl groups in carboxylated CNF films and helps the ester solvents present in the electrolyte to be absorbed more quickly.

In order to make a relative comparison of ionic conductivity among carboxylated CNF samples, 0.5 wt. % carboxylated CNF solution immersed membranes were employed in symmetrical cells. As depicted in FIG. 2d it can be seen that an increase in surface charge increases the ionic conductivity, indicating that carboxylate groups are more favourable to ion transfer than hydroxyl groups.

### Preparation of Sulfur Cathode

Cathode slurries were prepared by dry mixing all components using a magnetic stirring bar (600 rpm, room temperature and dry environment) in the following order. Sulfur (0.7 g) and conductive carbon powder (0.2 g) were mixed for 24 hours, followed by adding the different carboxylated CNF powders (0.1 g) to the mixture and continuing the dry mixing of all three components for another 24 hours. Then, 3 mL of deionised (DI) water was added to the 1 g of well-mixed components. All components were mixed in water with a magnetic stirring bar (600 rpm, room temperature and air environment) for 12 hours to produce a homogenous slurry. All sulfur cathode slurries were coated by a lab-scale doctor blade on a battery-grade Al foil and dried at room temperature for 6 hours, followed by 12 hours drying at 80° C. under vacuum to remove all traces of solvent. Calendering was not performed on the cathodes before both coin and pouch cell assembly.

The cathode slurries were prepared by mixing 10 wt. % carboxylated CNFs, 70 wt. % sulfur particles and 20 wt. % carbon particles. The structures of the cathode slurries were also examined by polarized light microscopy. As shown in FIG. 1c, there is no trace of any birefringent structure when native CNFs are used.

In contrast, the carboxylated CNFs are characterised by high surface charge and low aspect ratio. At the same solid content, the slurry with carboxylated CNF contains a higher number density of fine-fibres which can form domains. As depicted in FIG. 1d, the carboxylated CNF slurry forms liquid crystalline domains, which is evident from the high retardance patches exceeding the size of the individual fibres. These long-range ordered structures indicate the possible formation of a layer-by-layer structure in the 3D films.

Further tests indicated that this self-organization ability of the slurry is concentration-related and likely driven by the enhanced osmotic pressure resulting from the increase of counter-ion charges. In the low concentration slurry (3.3 mg/ml), it is noted that the carboxylated CNF shows optical retardance dispersed in the isotropic media. The isotropic media is the carbon slurry that does not possess any optical retardance (FIG. 1e). At a higher concentration of 33.3 mg/ml (FIG. 1f), the proportion of crystalline carboxylated CNF increased in the slurry, as evident from the image. Finally, the slurry at 333.3 mg/ml (FIG. 1g) shows high retardance patches. With increasing fraction of nano-fibers in the dispersion, fibers become orientationally ordered driven by decreasing orientational entropy. This loss in orientational entropy is compensated by increasing the translational entropy thus freeing up more space for new fibers as they become orientationally aligned. These results suggest that even with sulfur and carbon particles present in the free volume in carboxylated CNF domains, the cathode can still form an ordered-structure driven by osmotic pressure during drying.

### Morphology and Electrical Conductivity of Cellulose Nanofibre Containing Cathodes

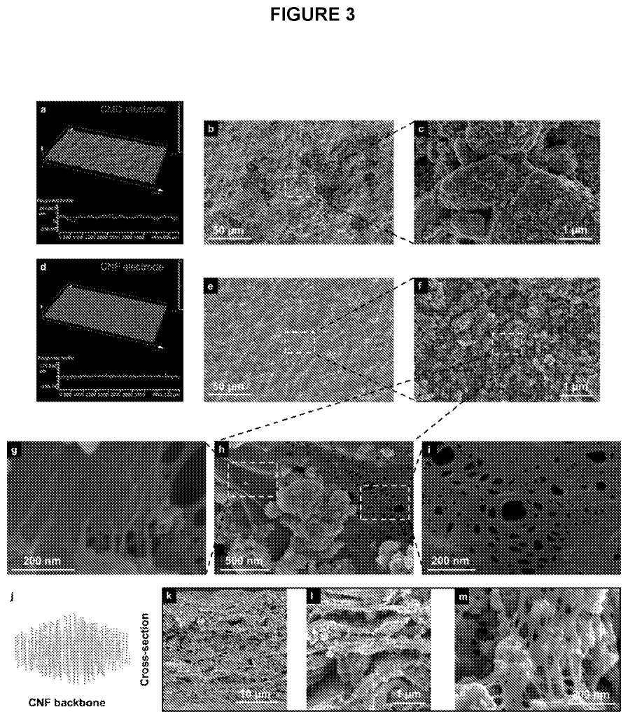

A profilometer was employed to examine the morphology of the cathodes. For the cathode with CMC as binder (FIG. 3a), the surface is uneven and has around 276 μm height difference according to the roughness profile. The scanning electron microscopy (SEM) image supported this observation. Pits can be clearly identified on the surface of a cathode prepared with CMC (FIG. 3b). The microstructure of the cathode was studied under high magnification SEM, as shown in FIG. 3c, and the image depicts a severe aggregation of the particles. In contrast, a cathode prepared with carboxylated CNF (CNF2) shows relatively lower surface roughness with approximately 165 μm height different (FIG. 3d). The SEM images of the carboxylated CNF cathode provide further evidence of the smooth surface (FIG. 3e). Further the uniformly distributed particles of the carboxylated CNF cathode are clearly observed in FIG. 3f.

The texture of the carboxylated CNF is portrayed in detail under high magnification top view SEM (FIG. 3g-i). FIG. 3g illustrates an interlocking and mechanically-robust microstructure of the carboxylated CNF in the sulfur cathode. Another area of the carboxylated CNF is shown in FIG. 3h and highlighted in FIG. 3i. This area of carboxylated CNF displays a highly porous structure. As illustrated in FIG. 3j, carboxylated CNF serves as a backbone of the cathode and supports a three-dimensional architecture through the entire cross-section of the cathode. The cross-sectional SEM images are shown in FIG. 3k-m, layer-by-layer and segregated structures are consistent throughout the carboxylated CNF cathode. This property is likely favourable for ionic transport due to the excellent electrolyte retaining property and shortened transport routes for ions. Also, these mesoporous pores accommodate for the volume expansion of sulfur particles during charge and discharge to maintain the cathodes' integrity.

The porosity of the lithium sulfur cathode can be estimated based on the thickness measure from the SEM cross-section and the equation,

$$ρ = \frac{V ( cathode ) - {V}_{dense} ( cathode )}{V ( cathode )}$$

wherein V(cathode) is the geometric volume of the electrode calculated using the thickness of the cathode and V_{dense}(cathode) is the dense volume of cathode, calculated by the measured mass of the coating and dividing it by the average density of all the cathode components determined by gas pycnometer.

The calculated number is 33.6% porosity for the cathode, which is considerably lower than previously reported sulphur cathodes. The highly negatively charged carboxylated CNF has a significant impact on the cathode architecture. It helps retain the porous structure but also compress the cathode with repulsive force. Positronium annihilation lifetime spectroscopy (PALS) tests indicated a relationship between CNF surface charge and pore size. The pore diameter decreased from 0.428 nm (CNF1.2) to 0.411 nm (CNF2) as the surface charge increased. The synergistic effects of the uniformly distributed pores and relatively high compact cathode are favourable for the volumetric energy density valuation.

### Examination of the Electronic and Ionic Conductivities of the CNF Thick Cathodes

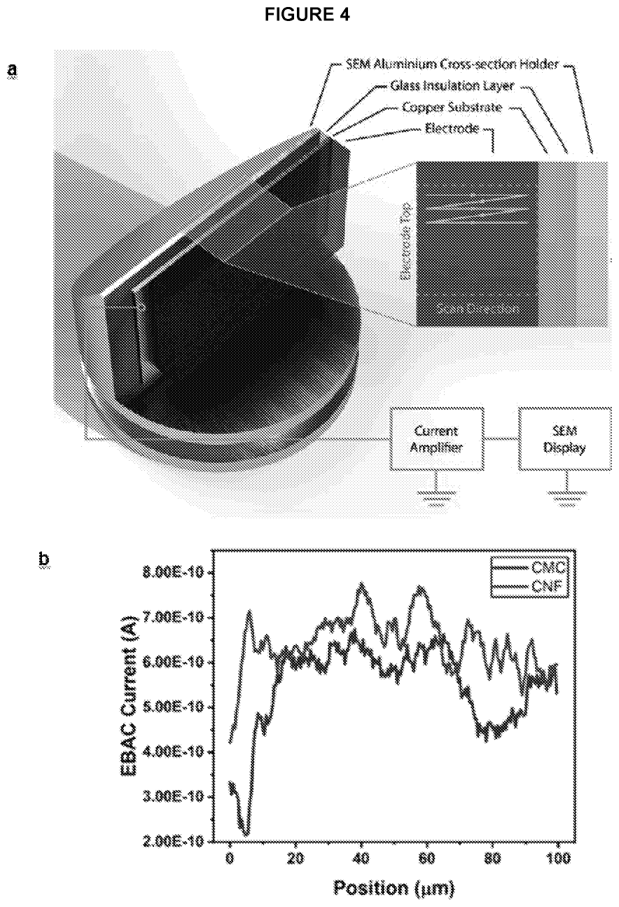

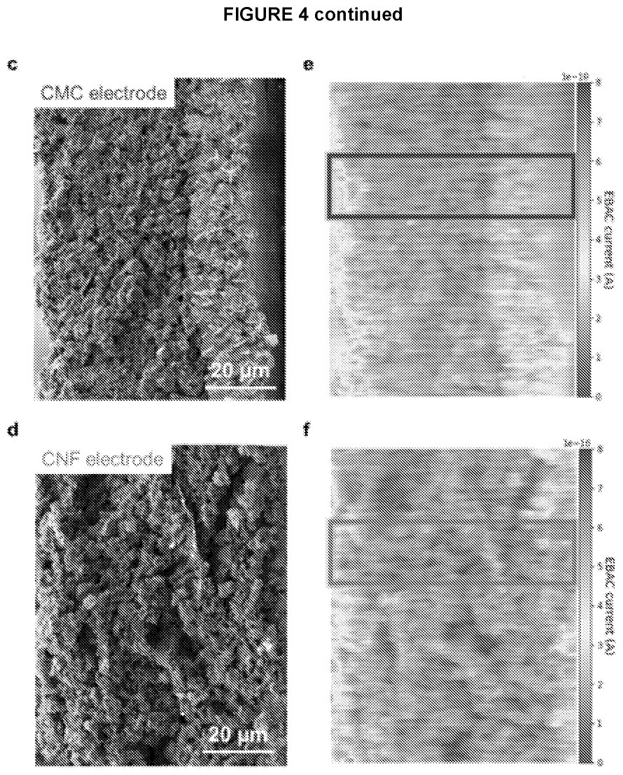

Electron beam absorbed current (EBAC) measurements were conducted to evaluate the electrical properties of CMC and carboxylated CNF thick cathodes, equalling 14 mg cm⁻² sulfur mass loading. As illustrated in FIG. 4a, a movable current source was provided by the scanning electron beam in the SEM. The external circuit measured the localized absorbed current that flowed between the electron probe incident position and cathode substrate. The absorbed current profile perpendicular to the cathode thickness direction from each cathode (boxed areas in FIGS. 4e and 4f) was captured by an EBAC amplifier and plotted in FIG. 4b. What can be clearly seen in this plot is that the average EBAC current from the carboxylated CNF cathode is greater than that from the CMC cathode. Although EBAC measurement is sensitive to sample surface roughness and porosity due to the variation of secondary and backscattered electron emissions, it could be used as an indicative technique for measuring electrical conductivity provided that the two samples are of the same composition and similar porosity. In addition, the current was averaged perpendicular to the profiling direction within each box to minimise the influence of surface roughness in different samples. The in-plane conductivities of the CMC cathode and carboxylated CNF cathode were also tested by measuring the resistance between the top and between the cathodes. The resistance of the CMC cathode and carboxylated CNF cathode is 61.1 ohms and 34.5 ohms, respectively, suggesting better electrical/electronic conductivity of carboxylated CNF cathodes compared to the CMC cathode.

It is also noted that the EBAC current profile fluctuates in a smaller range in the carboxylated CNF cathode (standard deviation 5.48×10⁻¹¹) compared to that in the CMC cathode (standard deviation 6.48×10⁻¹¹), which suggests a more uniformly distributed electronic conductivity of the carboxylated CNF cathode even though with greater thickness. Further details can be obtained from the cross-sectional SEM on the CMC cathode (FIGS. 4c and 4d) and in-situ EBAC mapping (FIGS. 4e and 4f). It is notable that there is a distinct phase separation between the top and bottom parts in the CMC cathode in FIG. 4c. As a result of this phase separation, it shows a much lower EBAC current on the bottom part in FIG. 4e. Based on EDX line-scan profiles on the cross-section of CMC cathode and corresponding elemental mapping there is a relatively higher concentration of sulfur element and lower concentration of carbon element on the bottom region. This is attributed to the larger particle size and higher density of crystalline sulfur, which will settle down on the bottom of the cathode during the coating and drying process due to the low viscoelasticity slurry and unstable cathode structure. In comparison, there is no distinct phase separation in the carboxylated CNF cathode (FIGS. 4d and 4f), which suggests good rheology properties of carboxylated CNF cathode slurry and provides evidence of a more homogeneous distribution of the sulfur particles and conductive agent (carbon).

Ionic conductivities were examined using a cyclic voltammetry (CV). According to the Randles-Sevick equation, a series of cyclic voltammograms with different scan rates were used for calculation. The values of lithium-ion diffusion coefficient were evaluated to be 1.05×10⁻⁶ cm² s⁻¹ to 2.92×10⁻⁷ cm² s⁻¹ for the CMC cathode and 3.25×10⁻⁶ cm² s⁻¹ to 1.21×10⁻⁶ cm² s⁻¹ for carboxylated CNF cathode. The elevated lithium-ion diffusion coefficient for carboxylated CNF cathode confirms the enhanced lithiation/delithiation kinetics and ionic conductivities of a sulfur cathode with carboxylated CNF system.

### Coin Cell Assembly and Electrochemical Tests

A glass fibre interlayer (0.203 mm thickness, 16 mm diameter and 15.5 μm max pore size) was coated with an aqueous slurry mixture of 80 wt. % carbon and 20 wt. % Gum Arabic (8 mL of deionised (DI) water was added to the 1 g of well-mixed components), acting as an conductive layer on the sulfur cathode. To cooperate with the sulfur cathode with different sulfur loading, the mass of carbon content on the aforementioned carbon coated glass fibre interlayer was 1 mg cm 2 for sulfur cathode with a sulfur loading of 3 mg cm⁻², 1.5 mg cm 2 for sulfur cathode with a sulfur loading of 6 mg cm 2, and 2 mg cm 2 for sulfur cathode with a sulfur loading of 11 mg cm 2. Therefore, the total sulfur content including sulfur cathode and conductive interlayer was 56.7%-62.1%. A Celgard separator (Celgard 2730, 20 μm thickness, 16 mm diameter, 1 μm pore size, and 43% porosity) was used as the separator. The electrolyte (<0.003% water content) was prepared by dissolving 1 M Bis (trifluoromethane) sulphonamide lithium (LiTFSI) and 0.5 M lithium nitrate (LiNO₃) in DOL and DME (1:1, v/v) in an argon-containing glovebox (<0.1 ppm H₂O and <0.1 ppm O₂). The electrolyte to sulfur ratio was in the range of 8.6-22 μL mg⁻¹, depending on the sulfur loading. For example, for the cathode at 3 mg cm⁻², 15 μL of electrolyte was used to wet the cathode. To wet the carbon coated glass fibre and Celgard separator, 50 μL of electrolyte was used. For the cathode with 6 mg cm 2, 20 μL of electrolyte was used to wet the cathode. To wet the carbon coated glass fibre and Celgard separator, 60 μL of electrolyte was used. For the cathode with 11 mg cm 2, 25 μL of electrolyte was used to wet the cathode. To wet the carbon coated glass fibre and Celgard separator, 70 μL of electrolyte was used. Typically, an increased amount of electrolyte was used for increased sulfur loading of the cathode. An E/S ratio larger than 20 μL mg⁻¹ is defined as electrolyte-flooded conditions and an E/S ratio lower than 5 μL mg⁻¹ is defined as lean-electrolyte conditions.

For coin cell assembly, all the steps were conducted in argon glovebox and electrochemical tests were done by EC-lab (Bio-logic) under air atmosphere and room temperature. EIS measurements were conducted by potentiostatic signal with 1 mHz to 1 MHz frequency range, 6 data points pre decade of frequency, 10 mV rms alternating current (AC) voltage and 2.8 V vs E_{ref} direct current (DC) voltage.

### Coin Cell Testing and Electrochemical Characterization of CNF Cathodes

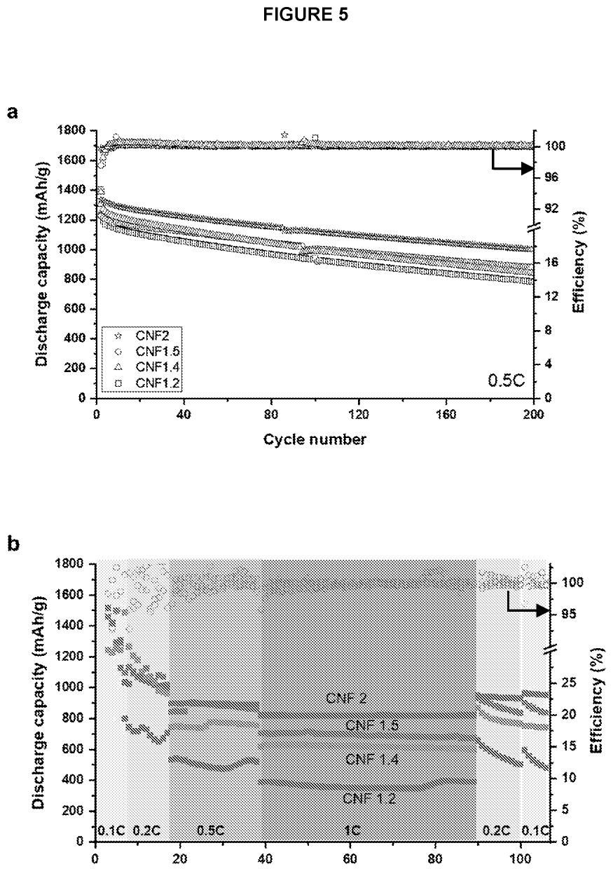

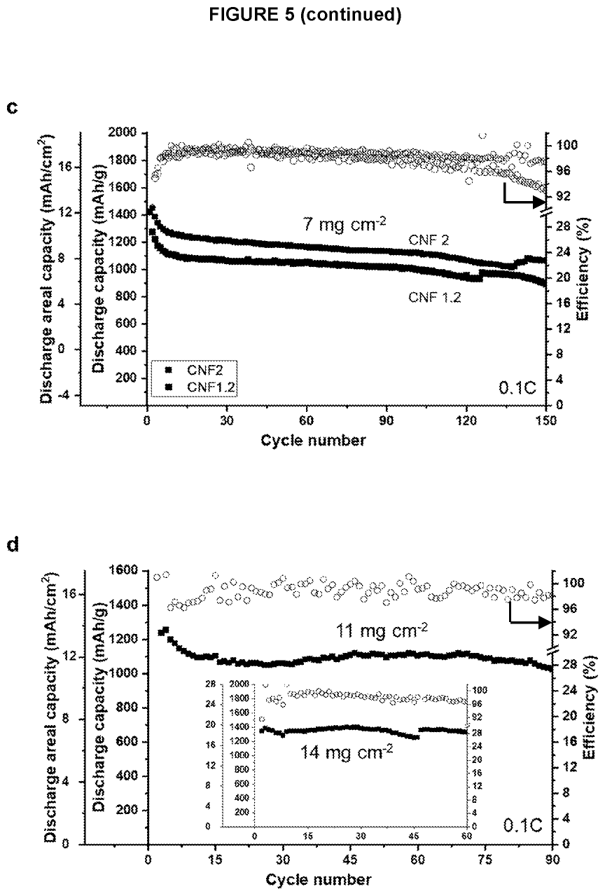

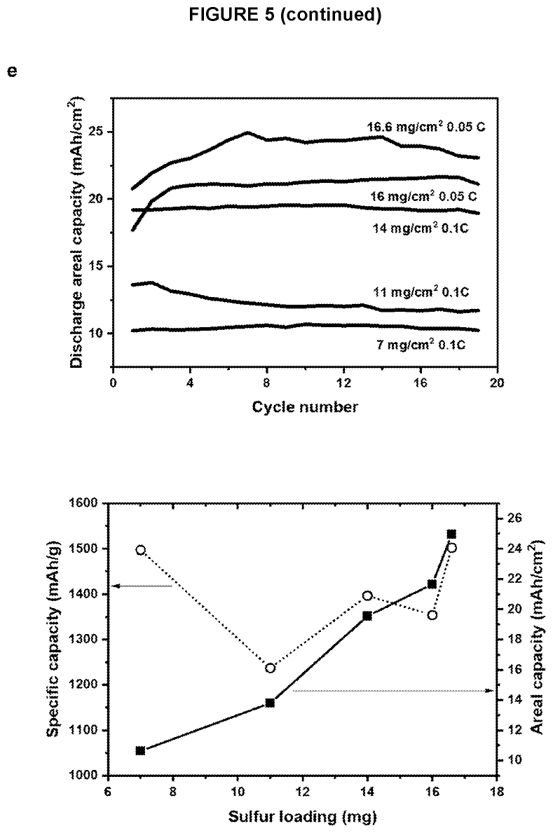

To verify the impact of different carboxylated CNF cathodes on cycling performance, coin cells were configured with cathodes composed of sulfur, carbon and carboxylated CNF with various surface charges. The coin cells were cycled under 0.5 C-rate (0.5C) for 200 cycles. As plotted in FIG. 5a, the results indicate that all carboxylated CNF cathodes can establish a relatively stable cycle life under a high charge-discharge rate, whereas the capacity and capacity retention are increasing with enhanced CNF surface charges. Likewise, as shown in FIG. 5b, cathodes consisting of carboxylated CNF with higher surface charges proved to have improved rate capability from 0.1C to 1C. These results may be explained because carboxylated CNFs with higher surface and lower aspect ratios have better electrolyte wettability and more efficient Li ion transportation.

Given the self-support architecture, as well as intensified electronic and ionic conductivities among the carboxylated CNF thick cathodes, the coin cell performance tests were performed using cathodes with high sulfur loading. CNF2 and CNF1.2 based cathodes with a sulfur loading of 7 mg cm⁻² were cycled under 0.1C. The comparative results (FIG. 5c) demonstrated that the CNF2 based cathode has improved stability and higher specific capacity. Moreover, the CNF2 based cathode with ultrahigh sulfur loadings of 11 mg cm⁻² and 14 mg cm⁻² (FIG. 5d) also maintained a high reversible capacity with around 98% coulombic efficiency. The tolerance of the cathode to sulfur loading was further explored to 16.6 mg cm 2, and the results are shown in FIG. 5e. The areal capacity of the CNF2 based cathode is as high as 25 mAh cm 2 with good stability retention. The relationship between specific capacity and areal capacity versus sulfur loading is depicted in FIG. 5f. It is notable that the specific capacity of the CNF2 based cathode is no longer decreasing as sulfur loading increases. Specific capacity fluctuating between 1200 and 1500 mg cm 2 of the thick CNF2 based cathode is a sulfur loading independent parameter that is distinguished from prior art lithium-sulfur batteries. The areal capacities of the batteries are continually increasing as the sulfur loading increases, which means the thick cathode does not hinder the utilization of the active material.

### Pouch Cell Preparation

Sulfur cathodes with around 4 mg cm⁻² were cut to be 3 cm×5 cm (cathode and Al substrate). Sulfur cathodes with around 6.5 mg cm 2 were cut to be 6 cm×5 cm (cathode and Al substrate). For double-sided cathodes, a sulfur slurry was coated on the back of single sided cathodes, yielding some sulfur loading on both sides. Li foil (0.1 mm or 0.05 mm thickness) was cut to the same size (3 cm×5 cm) as sulfur cathode. The Al tab was welded on the as prepared cathode, and a Ni tab was adhered on the Li anode by conductive Cu tap/two spot welder. Subsequently, carbon coated glass fibre interlayer or carbon nanotube (CNT) paper interlayer was stacked on the Celgard separator, followed by the cathode on top of the interlayer. Then, a piece of Li anode was placed on the other side of the Celgard separator. Between 3.5 and 5 μL of electrolyte was injected into the stack and the package was sealed under vacuum. All cells were assembled in an Ar-containing glovebox (<0.1 ppm H₂O and <0.1 ppm O₂).

### Validation in Ah Level Li—S Pouch Cells

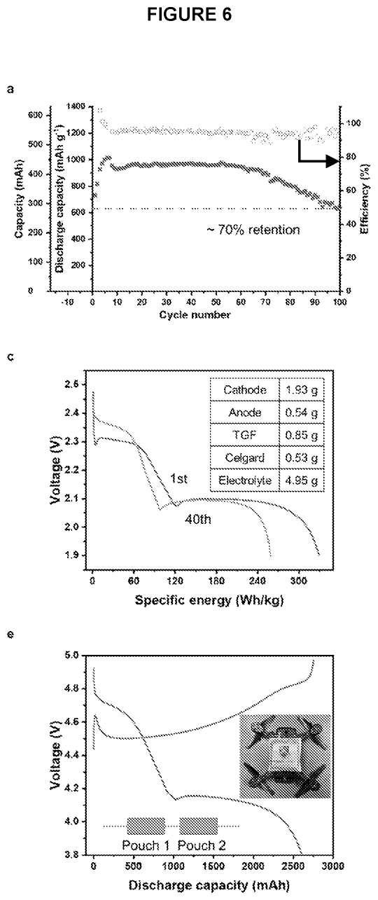

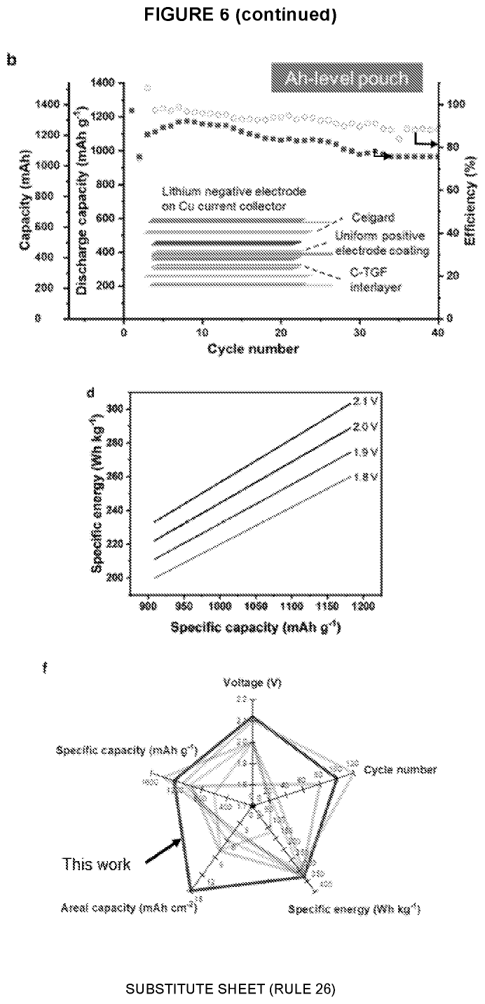

Given the outstanding coin cell performance of the CNF2 based cathode, a pouch cell was assembled with 450 mg sulfur loading in a double-sided cathode with dimensions of 3 cm×4.5 cm. The 450 mg pouch cell was cycled under 0.05C. The cell showed a specific capacity of over 900 mAh g 1 with a capacity retention rate of 70% for 100 cycles and a high coulombic efficiency of >95% (FIG. 6a).

An Ah-level CNF2 based cathode pouch cell was also fabricated, as illustrated in the insert diagram in FIG. 6b, to validate the prototype of high sulfur loading, thin Li anode and lean electrolyte operation. Parameters include 12 mg cm⁻² sulfur loaded double-sided cathodes, 1.35 negative to positive capacity ratio (N/P ratio) and 5ul mg⁻¹ electrolyte to sulfur ratio (E/S ratio). As plotted in FIG. 6b, the Ah-level pouch cell showed around 1200 mAh g⁻¹ specific capacity at 0.05C (equalling to 82 mA g⁻¹ current density), suggesting a high sulfur utilization even under operation with a high sulfur loading and a high current density. As a result, the cell delivers practical specific energy of 330 Wh kg⁻¹. Each component's weight for the calculation is tabled in the insert card in FIG. 5c. From the discharge plot depicted in FIG. 6c, the Ah-level pouch establishes a standard discharge profile and retains second platforms at 2.1V from the first cycle to the fortieth cycle.

The specific energy of the pouch cells was evaluated based on the equation:

$${E}_{g} = \frac{VC}{\sum {m}_{i}}$$

E_{g}: specific energy (Wh kg⁻¹)
V: output voltage (V)
C: output capacity (mAh)
Σmᵢ: total weight (including cathode, anode, conductive interlayer, separator and electrolyte)

As illustrated in FIG. 6c, the specific energy significantly decreased with low nominal voltage with the same specific capacity and total weight. For example, the calculated specific energy is only 260 Wh kg⁻¹ with 1.8V nominal voltage but is 300 Wh kg⁻¹ with 2.1V nominal voltage. The nominal voltage is dominated by the reaction kinetics in batteries, requiring good ionic and electronic conductivity in the cells. The present Ah-level pouch maintains a 2.1V nominal voltage even with a leaner electrolyte condition (5ul mg⁻¹) and a thick sulfur loading cathode (12 mg cm⁻¹), which can be attributed to the optimized architecture of the CNF2 based cathode. The dimensions of the pouches were measured, and the calculated volumetric energy density was 367 Wh L⁻¹.

The performance of the present pouch cell was further examined by powering a drone, which requires high gravimetric energy density and high power (current density). The plot in FIG. 6e shows the cycling profile of two 2.5 Ah pouches connected in series to provide the drone's operational voltage. The trial fly test of the drone demonstrated that the Li—S pouch pack was able to support 10 minutes hovering time before reaching the cut-off voltage. The capacity test of the after-service pouch pack indicated only one third of the capacity was consumed during the 10 minutes trial fly, which means the hover time can be potentially tripled with optimised voltage regulator and control board design.

As shown in FIG. 6f, the CNF2 based cathode pouch cells combine high specific energy, long cycle life and high specific capacity. Notable are the ultrahigh areal capacity of 15 mAh cm⁻² and the standard nominal voltage. The presently disclosed pouch cell outperforms other reported Ah level Li—S pouch cells.

### Summary of Key Features and Comparative Systems

Sulfur cathodes prepared by mixing 70 wt. % sulfur, 20 wt. % carbon and 10 wt. % different binder systems in deionized (DI) water were compared and the results are collected in the Table. Systems 1 and 2 employed carboxymethyl cellulose (CMC), a commonly used binder in battery electrode fabrication, both in wet mixing (system 1) and dry mixing (system 2). A previous publication demonstrated that through a dry-mixing method of the solid components prior to addition of water, CMC enables the formation of strong bridging bonds between sulfur and carbon particles (see international patent application no. PCT/AU2019/051239). System 3 employed a CMC glucose binder as disclosed in Y. Huang et al, Nature Communications, (2021), 12:5375. System 4 is according to the present disclosure and utilised a carboxylated CNF having about 2 mmol/g carboxyl group loading (CNF2).

| | | Cathode | Viscosity | | Maximum areal | |
|---|---|---|---|---|---|---|
| | | slurry | (Pa · s) of | | capacity | |
| | | solvent | cathode | | (mAh g⁻¹) and | Electrolyte |
| | | content per | slurry at | Porosity | corresponding | to sulfur |
| | | gram of | 0.01 s⁻¹ | of | sulfur loading | content |
| System | | solids (ml) | shear rate | cathode | (mg cm⁻²) | ratio (μl/mg) |
| 1 | Wet-mixing CMC | 3.0 | 738.0 | 54.0% | 9.7 / 12.0 | 6-8 |
| | (Control experiment) | | | | | |
| 2 | Dry-mixing CMC | 1.5 | 45100.0 | 57.0% | 18.7 / 13.0 | 7-12 |
| | (PCT/AU2019/051239) | | | | | |
| 3 | CMC/G system | 3.0 | 23.2 | 56.8% | 12.6 / 10.5 | 6-11 |
| 4 | Carboxylated CNF | 3.0 | 1152.0 | 33.6% | 25.0 / 16.6 | 3.5-5 |

From the results, system 4, according to the present disclosure, possesses a desirable range of features, including a cathode slurry viscosity enabling ease of processing, a very low cathode porosity, high areal capacity at high sulfur loading and low electrolyte to sulfur volume to weight ratio.

### Ex Situ Post-Mortem Study of Li—S Pouch Cells

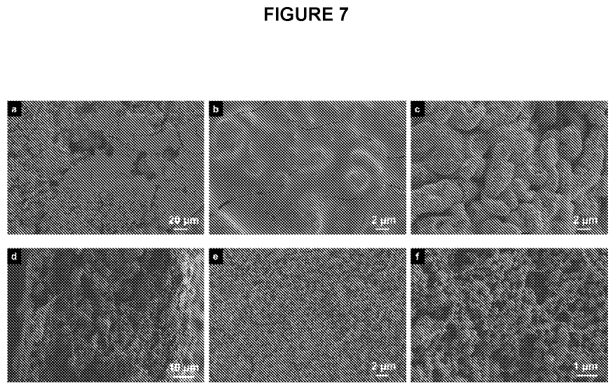

After intense cycling, pouch cells were disassembled, and lithium metal anodes and sulfur cathode were washed by DOL/DME and collected for SEM imaging. As illustrated in FIG. 7a, the surface of the lithium anode has two different morphologies. The first one (FIG. 7b) is a thick solid electrolyte interphase (SEI) layer film covered on emerging stone shape morphology for lithium plating. Another part (FIG. 7c) of the lithium surface is packed with the mature stone shape with a low surface area instead of the harmful dendritic growth often observed in previously reported systems. Such a desired lithium plating behaviour maintains the integrity of the SEI layer, which can be attributed to the controlled lithium polysulfide access to the lithium anode. This regulation ability of the system is a synergetic effect of highly negatively charged CNFs in the cathode which hinder the migration of the negatively charged polysulfide from the cathode and the carbon-coated thin glass fibre interlayer to restrict the transport of lithium polysulfide.

As depicted in the cross-sectional (FIG. 7d) and top-view (FIG. 7e) SEM of the CNF based cathode on the full delithiation state, the cathode develops no major cracks after cycling, benefiting from the segregated microstructure for accommodating volume changes during cycling. More structural details are provided by higher magnification images (FIG. 7e). The CNF based cathode demonstrates preservation of the binding between particles, which indicates the high robustness of the carboxylated CNF backbone.

### Cellulose Nanofibre Microscopy Analysis

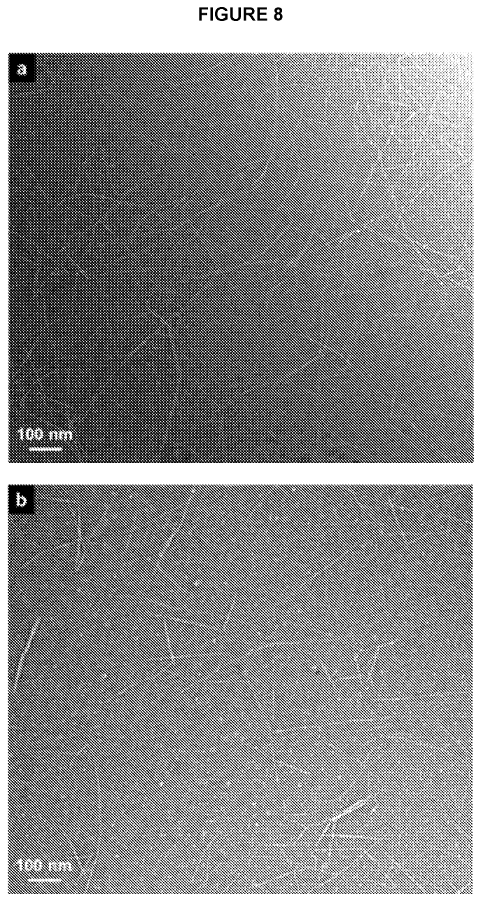

Dilute suspensions of the native CNFs and carboxylated CNFs in water (˜ 0.001% by weight) were sonicated with an ultrasonic probe at 70% amplitude for 2 min and analysed by transmission electron microscopy. FIG. 8 shows the images.

The samples were disintegrated into nanofibres with measured fibril diameter less than 4 nm. The native CNF sample (FIG. 8 (a)) showed long and aggregated nanofibres (fibril length of about 1000 nm), whereas the carboxylated CNF sample (FIG. 8 (b)) showed shorter, individual nanofibres with improved separation (fibril length of 500 nm).

### Analysis Techniques

### Scanning Electron Microscopy Imaging and EDX Mapping.

Freshly prepared cathode samples were mounted on an aluminium stub with conductive carbon tap and coated with iridium for front section and cross-section imaging. Nova 450 field emission scanning electron microscope (FESEM) and Magellan 400 FESEM were used for secondary electron imaging and energy dispersive spectroscopy mapping (EDX). For ex situ post-mortem SEM studies, all cells were terminated at full charge before disassembling in an argon glovebox. Cycled electrodes (cathode and anode) were washed with 1 ml of DOL/DME (1:1, v/v) and vacuum dried for 12 hours before mounting on aluminium stubs with conductive carbon tap in an argon glovebox. A transfer vacuum module was used to transfer cycled electrodes from the argon glovebox to a Merlin FESEM for analysis.

### Transmission Electron Microscopy Imaging

Transmission Electron Microscopy (TEM) was performed using an FEI Tecnai F20. Dilute suspensions of the native CNFs and carboxylated CNFs (˜ 0.001%) were sonicated with an ultrasonic probe at 70% amplitude for 2 min and were allowed to dry on plasma-cleaned copper grids. The samples were then stained with 2% uranyl acetate, air dried, and examined at 200 kV.

### Rheology Measurements

Rheological measurements were performed using a strain-controlled ARES G2 rheometer (TA instruments, USA) using a cone and plate geometry (dia-50 mm, cone angle−2°). A constant gap of 0.045 mm and temperature of 23.00±0.01° C. was maintained during the measurements. For steady-state measurements, viscosity change as a function of shear rate ranging from 0.1 to 100 s⁻¹ was recorded. The amplitude sweep was performed at an angular frequency of 10 rad/s, in a range from 0.1% to 100% strain amplitude, to determine the linear viscoelastic (LVE) regime. Frequency sweep was performed over the range of 0.1 to 100 rad/s.

### Electron Beam Absorbed Current (EBAC) Measurements

EBAC measurements were performed in a FEI Nova NanoSEM 450 FEG SEM equipped with a DEBEN GW Type 31 amplifier. The battery electrode cross-section specimen was mounted on a thin glass slide for providing electrical isolation from the SEM stage. It was then attached to a cross-section specimen stub in an edge-on orientation with respect to the electron beam. Via a vacuum feedthrough, the electrode copper substrate was connected to the EBIC amplifier which converts the current signal into a voltage output in the range of 0-1 V, and subsequently digitised by SEM system into 16-bit grayscale values. All EBAC mappings were acquired using an electron beam at 5 kV, spot size 5 and 50 μm objective aperture, resulting in an incident beam current of around 5 nA. Scanning dwell time was set to a conservative 8.2 ms due to the limited amplifier bandwidth in quantitative mode. For each mapping, dark current was acquired by blanking the electron beam in the first few lines of scanning and then subtracted in the post-processing.

### Surface Roughness Measurements

Profilometry measurements of electrodes were performed using an Olympus LEXT OLS5000 laser confocal microscope. Each scan took approximately 5 min. The instrument automatically calculated arithmetic surface roughness Ra.

### Zeta Potential

Carboxylated and homogenised CNFs were subjected to centrifugation at 12,000 g for 5 min so as to separate any unfibrillated fibres. The resulting supernatants were analysed by dynamic light scattering and zeta-potential using a particle size and zeta potential analyser (Brookhaven Nanobrook Omni). Measurements were performed five times for each sample.

1. A sulfur cathode comprising:
a) a cellulosic composition comprising a plurality of anionically functionalised cellulose nanofibres;
b) one or more sulfur containing materials; and
c) one or more conductive materials.

2. The sulfur cathode according to claim 1, comprising:
2-20 wt. % of a cellulosic composition comprising a plurality of anionically functionalised cellulose nanofibres;
b) 60-80 wt. % of one or more sulfur containing materials; and
c) 10-30 wt. % of one or more conductive materials.

3. The sulfur cathode according to claim 1, comprising:
a) 5-15 wt. % of a cellulosic composition comprising a plurality of anionically functionalised cellulose nanofibres;
b) 65-75 wt. % of one or more sulfur containing materials; and
c) 15-25 wt. % of one or more conductive materials.

4. The sulfur cathode according to any one of claims 1 to 3, wherein the plurality of anionically functionalised cellulose nanofibres have one or more of the following characteristics:
a) a fibril diameter from about 0.1 nm to about 20 nm;
b) a fibril length from about 20 nm to about 1000 nm;
c) a fibril aspect ratio from about 10 to about 1000; and
d) a zeta potential more negative than about-60 mV.

5. The sulfur cathode according to any one of claims 1 to 4, wherein the one or more sulfur containing materials comprise one or more of elemental sulfur, Li₂S and MoS₂.

6. The sulfur cathode according to any one of claims 1 to 5, wherein the one or more conductive materials comprise one or more of carbon black, graphite, graphene, activated carbon, carbon nanotubes, and carbon fibre.

7. The sulfur cathode according to any one of claims 1 to 6, wherein the cathode has a porosity of less than 50%, or less than 40%.

8. The sulfur cathode according to any one of claims 1 to 7, wherein the cathode has an arithmetic surface roughness of less than 25 μm.

9. The sulfur cathode according to any one of claims 1 to 8, wherein the transportation of polysulfide anions within the cathode is hindered relative to a sulfur cathode absent the cellulosic composition.

10. The sulfur cathode according to any one of claims 1 to 9, wherein the transportation of lithium ions within the cathode is facilitated relative to a sulfur cathode absent the cellulosic composition.

11. A lithium sulfur battery comprising a lithium anode, a separator, the cathode according to any one of claims 1 to 10, and electrolyte disposed between the anode and cathode.

12. The lithium sulfur battery according to claim 11, wherein the ratio of electrolyte volume to sulfur weight is less than about 6.0 μl/mg.

13. The lithium sulfur battery according to claim 11 or claim 12, wherein the ratio of electrolyte volume to sulfur weight is from about 3.5 to about 5.0 μl/mg.

14. The sulfur cathode according to any one of claims 1 to 10, or the lithium sulfur battery according to any one of claims 11 to 13, wherein the plurality of anionically functionalised cellulose nanofibres have a fibril diameter from about 0.5 nm to about 10 nm, or from about 1 nm to about 6 nm, of from about 2 nm to about 4 nm.

15. The sulfur cathode according to any one of claim 1 to 10 or 14, or the lithium sulfur battery according to any one of claims 11 to 14, wherein the plurality of anionically functionalised cellulose nanofibres have a fibril length from about 40 nm to about 700 nm, or from about 70 nm to about 500 nm, or from about 100 nm to about 400 nm.

16. The sulfur cathode according to any one of claim 1 to 10, 14 or 15, or the lithium sulfur battery according to any one of claims 11 to 15, wherein the plurality of anionically functionalised cellulose nanofibres have a fibril aspect ratio from about 15 to about 750, or from about 20 to about 500, or from about 25 to about 200.

17. The sulfur cathode according to any one of claims 1 to 10 or 14 to 16, or the lithium sulfur battery according to any one of claims 11 to 16, wherein the plurality of anionically functionalised cellulose nanofibres have a zeta potential from about-60 mV to about-90 mV.

18. The sulfur cathode according to any one of claims 1 to 10 or 14 to 17, or the lithium sulfur battery according to any one of claims 11 to 17, wherein the plurality of anionically functionalised cellulose nanofibres are functionalised with one or more of carboxyl, phosphonate, sulfonate, sulphate, hydroxyl, nitrate, and carbonate.

19. The sulfur cathode according to any one of claims 1 to 10 or 14 to 18, or the lithium sulfur battery according to any one of claims 11 to 18, wherein the plurality of anionically functionalised cellulose nanofibres comprise greater than 1 mmol anionic groups per gram nanofibres, or greater than 1.5 mmol anionic groups per gram nanofibres.

20. The sulfur cathode according to any one of claims 1 to 10 or 14 to 19, or the lithium sulfur battery according to any one of claims 11 to 19, wherein the plurality of anionically functionalised cellulose nanofibres comprise from about 1 to about 4 mmol anionic groups per gram nanofibres, or from about 1.5 to about 4 mmol anionic groups per gram nanofibres, or from about 2 to about 4 mmol anionic groups per gram nanofibres.

21. The sulfur cathode according to any one of claims 1 to 10 or 14 to 20, or the lithium sulfur battery according to any one of claims 11 to 20, wherein the plurality of anionically functionalised cellulose nanofibres are functionalised with carboxyl groups.

22. The lithium sulfur battery according to any one of claims 11 to 21, wherein, during charging or discharging, the sulfur cathode facilitates the transport of lithium ions through the cathode.

23. The lithium sulfur battery according to any one of claims 11 to 22, wherein, during charging or discharging, the sulfur cathode hinders the transport of polysulfide ions through the cathode.

24. A cathode slurry composition comprising:
a) a cellulosic composition comprising a plurality of anionically functionalised cellulose nanofibres;
b) one or more sulfur containing materials;
c) one or more conductive materials; and
d) water.

25. The cathode slurry composition according to claim 24, wherein the ratio of water to the combined weights of components a), b) and c) is from about 1 ml/g to about 40 ml/g, or from about 3 ml/g to about 30 ml/g.

26. The cathode slurry composition according to claim 24 or claim 25, wherein the viscosity of a 3 ml/g slurry at 0.01 s⁻¹ shear rate is greater than about 1000 Pa·s when measured in the temperature range 20-25° C.

27. A method of preparing a cathode slurry composition according to any one of claims 24 to 26, comprising the step of mixing a cellulosic composition comprising a plurality of anionically functionalised cellulose nanofibres, one or more sulfur containing materials, one or more conductive materials, and water.

28. The method according to claim 27, wherein the cellulosic composition, one or more sulfur containing materials, and one or more conductive materials are dry mixed prior to mixing with water.

29. A cellulosic composition comprising a plurality of anionically functionalised cellulose nanofibres, said nanofibres having one or more of the following characteristics:
a) a fibril diameter from about 0.1 nm to about 20 nm;
b) a fibril length from about 20 nm to about 1000 nm;
c) a fibril aspect ratio from about 10 to about 1000; and
d) a zeta potential more negative than about-60 mV.

30. A method of preparing the cellulosic composition according to claim 29, comprising:
a) treating a source of cellulose with one or more agents capable of anionically functionalising cellulose nanofibres; and
b) subjecting the anionically functionalised cellulose nanofibres to shear conditions so as to reduce one or more fibril dimensions.

31. The method according to claim 30, wherein the agent is an oxidising agent.

32. The method according to claim 30 or claim 31, wherein the shear conditions in step b) comprise agitating an aqueous mixture of the anionically functionalised cellulose nanofibres.

33. The method according to any one of claims 30 to 32, wherein the shear conditions in step b) comprise one or both of ultrasonic homogenisation and high pressure homogenisation of an aqueous mixture of the anionically functionalised cellulose nanofibres.
